(19) United States
(12) Patent Application Publication
(10) Pub. No.: US 2026/0019935 A1
(43) Pub. Date: Jan. 15, 2026

(54) NEIGHBORHOOD RELAXATION FOR PHYSICAL CELL IDENTIFIER AND ROOT SEQUENCE INDEX ASSIGNMENT OPTIMIZATION

(71) Applicant: AT&T Intellectual Property I, L.P., Atlanta, GA (US)

(72) Inventor: Carlos Eduardo De Andrade, Gainesville, FL (US)

(73) Assignee: AT&T Intellectual Property I, L.P., Atlanta, GA (US)

(21) Appl. No.: 18/767,497

(22) Filed: Jul. 9, 2024

(51) Int. Cl. H04W 48/20; H04L 41/5009; H04W 24/10

(52) U.S. Cl. CPC H04W 48/20; H04L 41/5009; H04W 24/10

(57) ABSTRACT

A software-defined network (“SDN”) controller can execute a ranking application to determine a radio access network (“RAN”) node group including at least two RAN nodes for which a neighborhood relations ranking is to be computed. The SDN controller can determine at least one metric and a ranking function to be used in computing the neighborhood relations ranking. The SDN controller can fetch current neighborhood data for the at least two RAN nodes in the RAN node group. Based upon the at least one metric and the current neighborhood data, the SDN controller can compute the neighborhood relations ranking. The SDN controller can then provide the neighborhood relations ranking to user equipment operating in the RAN.

### BACKGROUND

The Physical Cell Identifier (“PCI”) and the Root Sequence Index (“RSI”) are the most critical parameters of Radio Access Networks (“RANs”). PCI and RSI are related to the radio access procedure for establishing download and upload channels between the user equipment (“UE”) and base station nodes (e.g., NodeB, eNodeB, gNodeB, and the like). Base station nodes provide radio access in specific geographical areas called cells. Cell coverage areas often overlap. Cells with overlapping coverage areas are referred to as neighbor cells. A RAN must assign different PCIs and RSIs for neighbor cells so that a UE can connect to the correct cell. A problem with this is the limited range of integer numbers for both PCI and RSI assignments. In 5G networks, for example, the PCI is limited to an integer in the range [0,1007], and the RSI is limited to the range [0,139] for short sequence preambles and the range [0,839] for long sequence preambles. Future generation technologies (e.g., 6G) may increase these ranges. However, while the numerology may change, network expansion may outpace the number of available PCI and RSI assignments. Mobile network operators (“MNOs”) often reserve some PCI and RSI values for special usage, such as fixed wireless, and therefore, in practice, these ranges are further limited. Moreover, the deployment of ultra-dense networks and heterogeneous networks only aggravates the PCI/RSI scarcity problem. The number of neighborhood relations is enormous in such networks. Multi-layer networks bring an additional challenge because each layer is often managed by an independent entity. This makes the PCI/RSI assignment even more complex across the layers that may interfere with each other.

Neighbor cells must have different PCIs and different RSIs with a minimum distance. Otherwise, a collision occurs, and the UE cannot connect to either cell. For example, a UE cannot establish a download channel from a cell if both neighbor cells have the same PCI. As another example, assuming an RSI minimum distance of 10, a UE cannot establish an upload channel because, although the RSIs of the neighbor cells are different, the RSIs are not set with the minimum required distance.

PCI confusion occurs when a cell has two neighbors with the same PCI. When a UE asks for handover, the base station does not know to which cell it should handover the UE. In other words, if second-level neighbors (i.e., neighbor of neighbors) have the same PCI of the current cell, then confusion may occur. Confusion occurs only when the same PCI neighbors of a cell are not direct neighbors. Otherwise, a collision would occur. For this reason, MNOs want to avoid all PCI confusions.

While collisions and confusions are the main technological constraints for PCI and RSI assignments, additional technological constraints exist. Although an MNO may optimize a large portion of the network at once, and therefore may obtain a better assignment overall, such an assignment may be deployed in batches due to limitations on the network controllers. Batch deployment may cause the PCI/RSI shuffle problem in which nodes of different deployment batches may have a temporal collision/confusion, and the batch cannot be deployed. The MNO may want to minimize or restrict the number of changes in the network. Also, certain changes cannot be done (i.e., blacklisted). MNOs may have other constraints for PCI and RSI assignments.

### SUMMARY

Concepts and technologies disclosed herein are directed to neighborhood relaxation for PCI and RSI assignment optimization. According to one aspect of the concepts and technologies disclosed herein, a software-defined network (“SDN”) controller can execute a ranking application to determine a radio access network (“RAN”) node group including at least two RAN nodes for which a neighborhood relations ranking is to be computed. The SDN controller can determine the RAN node group based upon a user selection of the RAN nodes to be in the RAN node group. The SDN controller can determine at least one metric. The at least one metric can be user-specified and/or fetched from a metric library. The metric library can include a plurality of key performance indicators (“KPIs”). The at least one metric can include at least one KPI of the plurality of KPIs in the metric library. The SDN controller can fetch current neighborhood data for the at least two RAN nodes in the RAN node group. Based upon the at least one metric and the current neighborhood data, the SDN controller can compute the neighborhood relations ranking. The SDN controller can then provide the neighborhood relations ranking to one or more UEs operating in the RAN. For example, the SDN controller can provide the neighborhood relations ranking to the UE via an application programming interface (“API”) called by an optimization application executing on the UE.

In some embodiments, the UE can define a plurality of ranking threshold. The UE can group neighborhood relations into top neighbors, regular neighbors, and ignored neighbors according to the ranking thresholds. The UE can determine a penalization function for violating at least one constraint. The UE can then apply the penalization function to the regular neighbors that violate the least one constraint.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative RAN in which aspects of the concepts and technologies disclosed herein can be implemented.

FIG. 2 is a block diagram illustrating aspects of an operating environment in which aspects of the concepts and technologies disclosed herein can be implemented.

FIG. 3 is a block diagram illustrating aspects of an illustrative RAN node capable of implementing aspects of the embodiments presented herein.

FIG. 4 is a flow diagram illustrating aspects of a method for building a neighborhood relations ranking, according to an illustrative embodiment of the concepts and technologies disclosed herein.

FIG. 5 is a flow diagram illustrating aspects of a method for utilizing the neighborhood relations ranking for PCI or RSI assignments, according to an illustrative embodiment of the concepts and technologies disclosed herein.

FIG. 6 is a block diagram illustrating an example computer system capable of implementing aspects of the concepts and technologies disclosed herein.

FIG. 7 is a block diagram illustrating an example mobile device capable of implementing aspects of the concepts and technologies disclosed herein.

FIG. 8 is a block diagram illustrating aspects of an illustrative network functions virtualization (“NFV”) platform capable of implementing aspects of embodiments of the concepts and technologies disclosed herein can be implemented.

FIG. 9 is a block diagram illustrating an example network capable of implementing aspects of the concepts and technologies disclosed herein.

FIG. 10 is a block diagram illustrating an example machine learning system capable of implementing aspects of the concepts and technologies disclosed herein.

### DETAILED DESCRIPTION

PCI and RSI assignments for radios in ultra-dense networks are extremely hard due to the density of the neighbor relations and the scarcity of PCI/RSI values available to be assigned. Therefore, many MNOs use custom approaches usually depending upon the available KPIs and vendors. In one aspect disclosed herein, a ranking application can create a neighbor relations ranking, which specifies how important a neighbor relation is for a given KPI or set of KPIs. The neighbor relations ranking can be provided to an optimization algorithm, which is agnostic to the KPI or specifics of the neighbor relation. More particularly, the nodes for which the PCI and/or RSI should be changed can be identified. This may happen when new nodes are deployed in the network or network conditions change. Once the nodes are identified, the neighbor relations ranking can be computed. One or more metrics (e.g., KPIs) can be identified, such as the number of handovers and/or the coverage overlap of each cell/node. A ranking function can then be applied. The intermediary production is a list of neighbor relations, ranked from the most important to the least important, according to the chosen KPIs and ranking functions. The KPIs and ranking functions can be determined by the user or can be fetched from historical usage for the set of nodes. Different markets can use different metrics. For instance, one market may use the “number of handovers,” and another market may use “coverage overlap.” Once the ranking is determined, it can be sent to an optimization component, which uses the ranking to create relaxations for PCI/RSI assignment constraints. This approach is more manageable from an optimization perspective than existing PCI/RSI assignment methods. Accordingly, the disclosed concepts and technologies facilitate generating more feasible or desirable solutions than the rigid and KPI-tailored approach used today.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, Drones, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of neighborhood relaxation for PCI and RSI assignment optimization will be presented.

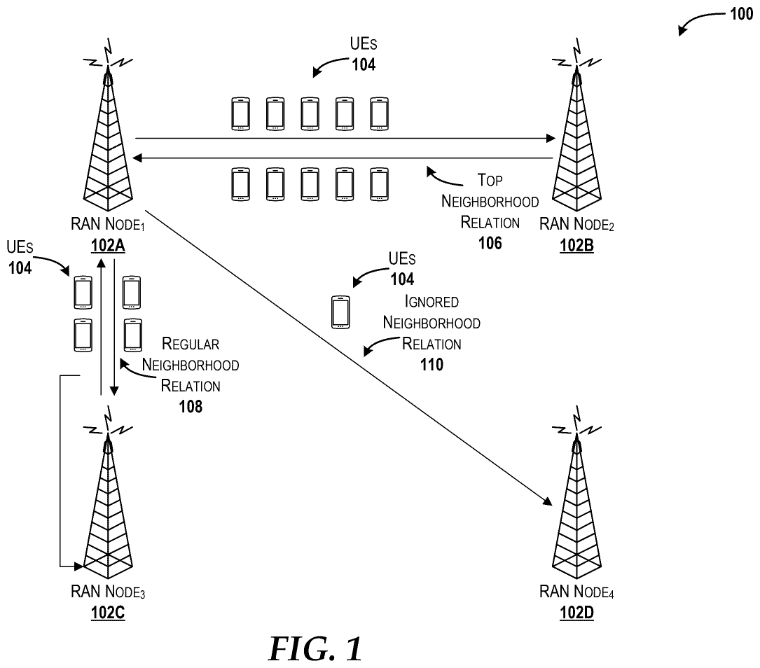

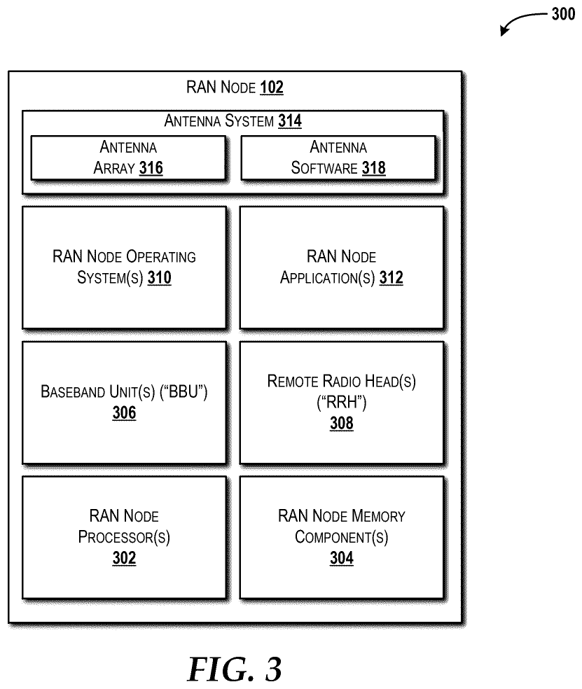

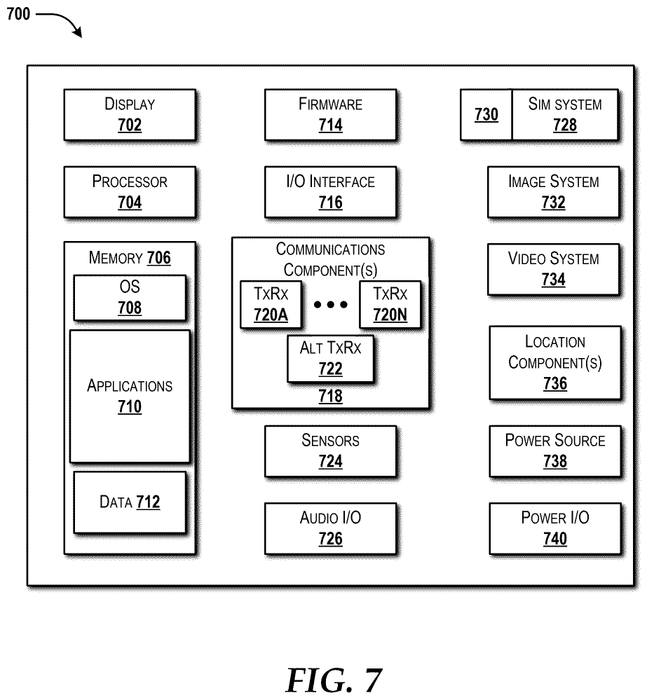

Referring now to FIG. 1, aspects of an illustrative RAN 100 for which aspects of the concepts and technologies can be applied will be described. The RAN 100 includes a plurality of RAN nodes 102A-102D (hereinafter referred to collectively as RAN nodes 102 or individually as RAN node 102). As used herein, a “RAN node” refers to a base station node that includes a radio receiver and/or transmitter that is/are configured to provide a radio/air interface. Accordingly, a RAN node 102 can include one or more base transceiver stations (“BTSs”), one or more NodeBs, one or more eNodeBs, one or more 5G new radio (“5G-NR”), one or more gNodeBs, and/or other networking nodes that are capable of providing a radio/air interface regardless of the technologies utilized to do so. A RAN node 102 can be in communication with one or more antennas (not shown), each of which may be configured in accordance with any antenna design specifications to provide a physical interface for receiving and transmitting radio waves. A more detailed RAN node architecture upon which the RAN nodes 102 can be based is illustrated and described herein with reference to FIG. 3. Each of the RAN nodes 102 can serve one or more user equipment (“UE(s)”) 104, such as mobile devices, computers, fixed wireless modem/router devices, and/or the like, within a given geographical area referred to herein as a “cell.” An example mobile device architecture upon which the UEs 104 can be based is illustrated and described herein with reference to FIG. 7.

The RAN nodes 102 can be neighbors with each other. In the illustrated example, the RAN node₁ 102A has a top neighborhood relation 106 with the RAN node₂ 102B, a regular neighborhood relation 108 with the RAN node₃ 102C, and an ignored neighborhood relation 110 with the RAN node₄ 102D. An MNO may consider two RAN nodes 102 to be top neighbors (i.e., the pair of RAN nodes 102 have a top neighborhood relation 106) if the MNO wants to strictly enforce all constraints or a specific group of constraints for that pair of RAN nodes 102. An example constraint can be that mod-4 PCI assignment is required for pairs of RAN nodes 102 with a large number of handovers between them. An MNO may consider two RAN nodes 102 to be regular neighbors (i.e., the pair RAN nodes 102 have a regular neighborhood relation 108) if the MNO wants to enforce as much as possible of all constraints or a specific group of constraints for that pair of RAN nodes 102. However, it is possible that some constraints may be violated. For instance, two neighbors may have only a few handovers between themselves, and therefore, the MNO may allow mod-4 PCI collision (i.e., a permissible violation constraint), but no direct PCI collisions (i.e., a strictly enforced constraint). An MNO may consider two RAN nodes 102 to be ignored neighbors (i.e., the pair of RAN nodes 102 have an ignored neighborhood relation 110) if the MNO determines that the relations can be ignored. For instance, the MNO may allow a collision between a pair of RAN nodes 102 that are enough of a distance from each other where handovers rarely, if ever, happen.

In some embodiments, the number of handovers can define neighborhood relations. The RAN node₁ 102A and the RAN node₂ 102B may be considered top neighbors because these RAN nodes 102 handover more UEs 104 within a given time window compared to other RAN node 102 pairs. In the illustrated example, ten UEs 104 are shown as participating in handovers between the RAN node₁ 102A and the RAN node₂ 102B. The number of UEs 104 shown participating in handovers among pairs of the RAN nodes 102 are shown individually for ease of explanation and not limitation. In real-world implementations, the number of UEs 104 participating in handovers among pairs of the RAN nodes 102 may be tens, hundreds, thousands, or even millions depending upon the scenario. Continuing with the illustrated example, the RAN node₁ 102A and the RAN node₃ 102C may be considered regular neighbors because these RAN nodes 102 handover only four UEs 104 within the same time window compared to the number of handovers between the RAN node₁ 102A and the RAN node₂ 102B in the top neighborhood relation 106. Lastly, the RAN node₁ 102A and the RAN node₄ 102D may be considered ignored neighbors because these RAN nodes 102 only handover one UE 104 within the same time window. It should be understood that the number of handovers associated with the top neighborhood relation 106, the regular neighborhood relation 108, and the ignored neighborhood relation 110 can be defined based upon a set of thresholds/parameters.

In other embodiments, metrics other than or in addition to handovers can be used to define the neighborhood relations. For example, other metrics may include, but are not limited to, overlap of coverage area, radio frequency interference, traffic patterns within the coverage area, and special node use (e.g., emergency services such as FirstNet and military operations). The metrics can include one or more key performance indicators (“KPIs”) associated with the performance of the RAN 100. As used herein, the term “metric” encompasses any measurable aspect of the operation of a RAN such as the RAN 100, including KPIs and the like.

The neighborhood relation categories—top neighborhood relation 106, regular neighborhood relation 108, and ignored neighborhood relation 110—are a subset of rank functions, which will be described in further detail herein. Alternatively, an MNO may want to use numerical ranks instead of neighborhood relation categories. However, neighborhood relation categories provide an aggregation abstraction for the ranks, often convening into a stratification meaning. Such stratification can be used within a granular/numerical ranking, thus providing the underlying optimization algorithm with a rich set of information about neighborhood relations among the RAN nodes 102.

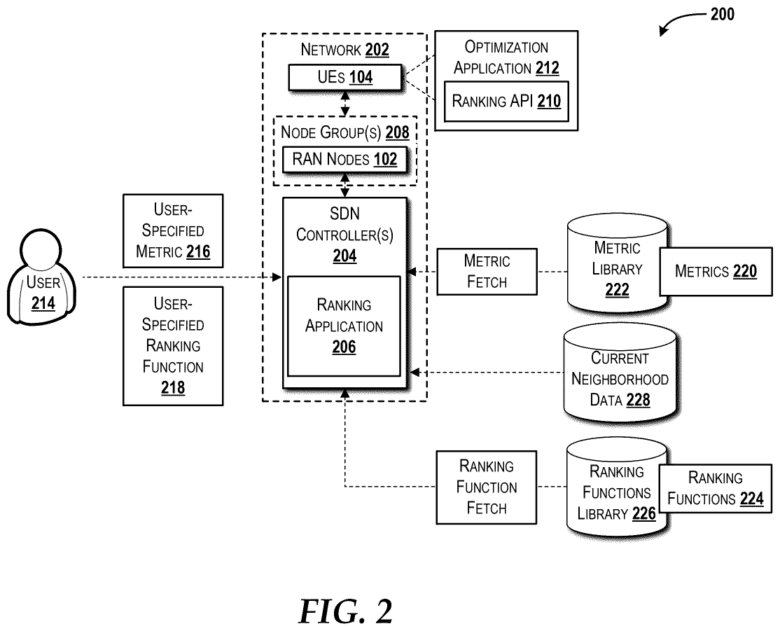

Turning now to FIG. 2, an operating environment 200 in which aspects of the concepts and technologies disclosed herein can be implemented will be described. The operating environment 200 includes a network 202 that can be or can include one or more wireless wide area networks (“WWANs”), which may, in turn, include one or more core networks such as a circuit-switched core network (“CS CN”), a packet-switched core network (“PS CN”), an IP multimedia subsystem (“IMS”) core network, multiples thereof, and/or combinations thereof. The WWAN can utilize one or more mobile telecommunications technologies, such as, but not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), 5G-NR, and the like. The RAN 100 (best shown in FIG. 1) can utilize various channel access methods (which might or might not be used by the aforementioned standards) including, but not limited to, Time Division Multiple Access (“TDMA”), Frequency Division Multiple Access (“FDMA”), Single Carrier FDMA (“SC-FDMA”), CDMA, wideband CDMA (“W-CDMA”), Orthogonal Frequency Division Multiplexing (“OFDM”), Space Division Multiple Access (“SDMA”), and/or the like to provide a radio/air interface to the UEs 104. Data communications can be provided in part by a RAN using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, 5G-NR, and/or various other current and future wireless data access technologies. Moreover, a RAN may be a GSM RAN (“GRAN”), a GSM EDGE RAN (“GERAN”), a UMTS Terrestrial Radio Access Network (“UTRAN”), an E-UTRAN, 5G RAN, any combination thereof, and/or the like.

The network 202 can be or can include a software-defined network (“SDN”), which can include SDN components such as one or more SDN controllers 204 that control aspects of the network 202. For example, the SDN controller(s) 204 can include one or more RAN SDN controllers that control aspects of the RAN 100. The SDN controller(s) 204 additionally can include one or more network edge SDN controllers and/or one or more network core SDN controllers. The SDN controllers 204 can obtain information from the parts of the network 202 for which each SDN controller is responsible, such as the RAN 100, the network edge (not shown), and the core network (also not shown). Based on network fault and performance information, the RAN SDN controller can make adjustments to the antenna or RAN parameters, the edge SDN controller can modify routes or priorities in edge routers to resolve failures or congestion, and the core SDN controller can modify routes or priorities in the core routers.

In the illustrated example, the SDN controller(s) 204 can execute a ranking application 206 to perform, at least in part, various operations disclosed herein, such as building a ranking of the neighborhood relations among the RAN nodes 102 within RAN node groups 208, each including two or more of the RAN nodes 102, and utilizing the ranking for PCI and RSI assignments. The ranking application 206 may expose a ranking function application programming interface (“API”) 210 through which the UEs 104 can utilize the ranking for PCI and RSI assignments to optimize connectivity to the RAN nodes 102 via an optimization application 212.

Given a set of neighborhood relations, a user 214, such as a network engineer, can provide to the SDN controller(s) 204, and specifically the ranking application 206, one or more user-specified metrics 216 and a user-specified ranking function 218 to be used to rank the set of neighborhood relations. For example, the user-specified metrics 216 can be the number of handovers for all neighborhood relations. Alternatively, the ranking application 206 can fetch one or more metrics 220 from a metrics library 222, which can be provided, at least in part, by the MNO and/or a third party. The ranking application 206 can fetch the metric(s) 220 used recently (e.g., within the last day, week, month, or year depending upon the needs of a given implementation) or the metric(s) 220 used most frequently for a given neighborhood relation. For instance, the ranking application 206 may select a coverage area for the neighborhood relation between the RAN node₁ 102A and the RAN node₂ 102B since this may be the metric 220 most frequently used between this RAN node 102 pair. Likewise, the ranking application 206 can fetch a ranking function 224 from a ranking functions library 226. Similar to the metrics 220, the ranking function 224 may be attached to historical usage according to the given RAN nodes 102. For example, a given market may use “the non-decreasing order of the average of the number of handovers within a week” for its neighborhood relations ranking.

The ranking application 206 can fetch current neighborhood relations and any associated metrics 220 for the given node group 208 (shown generally as current neighborhood data 228). For time series, aggregation of this data can be done at the database level or at the application level. Using the metric(s) 216/220 (user-specified and/or fetched), the ranking function 218/224 (user-specified or fetched), and the current neighborhood data 228, the ranking application 206 can compute the ranks according to the ranking function 218/224. In some implementations, due to the potentially time-consuming, resource-intensive, and expensive nature of this computation, this computation can be handled in a distributed fashion, such as among multiple ranking applications 206 executed by multiple SDN controllers 204 or at least partially offsite, such as in a cloud computing network. It is possible that the incoming data is not completely clear or ready to use. For instance, a given neighborhood relation may have several rankings. In such situations, the ranking function 218/224 can handle the incoming data directly or via one or more cleaning and normalization policies prior to handling. The ranking application 206 can then forward to the UEs 104, and specifically to the optimization application 212, the neighborhood relations ranking via the ranking API 210.

The neighborhood relations ranking can be utilized for PCI assignment via the optimization application 212. In PCI assignment, the neighborhood relations can be grouped into three categories as described above: top neighbors, regular neighbors, and ignored neighbors. A top neighbor ranking is less than or equal to a ranking threshold “top_rank.” For such RAN nodes 102, all PCI constraints are enforced, especially the module-assignment constraints. A regular neighbor ranking is greater than the ranking threshold “top_rank,” but less than the ranking threshold “ignored_rank.” For these neighbors, module-assignment collision may be allowed, but no direct collisions or confusion are allowed. Alternatively, direct collisions or confusions may be allowed but module collusions may be penalized using a penalization function described herein below. An ignored neighbor ranking allows for one or more constraints (if not all) to be relaxed. That is, the relation will be nonexistent for that set of constraints. In general, ignored neighbors can be removed from the optimization and no constraint takes effect over those pairs of nodes. An ignored neighbor has a rank greater than or equal to the ranking threshold “ignored_rank.” It should be understood that there may be other ways to use this concept of partial relaxation based upon the structure of the problem (in this case, neighbor relations). Notably, the concepts and technologies disclosed herein enable MNOs to partially relax easily violated constraints, which may find additional applicability outside of the specific use cases described herein.

The definition of the thresholds “top_rank” and “ignored_rank” can be given by the user 214 or can be extracted from historical usage for a specific node group 208. For example, the user 214 (on behalf of the MNO) may define “top_rank=10” and “ignored_rank=30” for market “A”, and “top_rank=25” and “ignored_rank=50” for market “B”. These thresholds also can be defined dynamically by the PCI assignment algorithm executed by the optimization application 212. The PCI assignment algorithm may start with large “top_rank” and “ignored_rank,” which probably will result in an infeasible use case (i.e., no feasible solution or assignment can be found using such values). Then, the optimization application 212 may reduce its values iteratively until a feasible solution or a solution within the limits expected by the user 214 is found. Any reducing strategy can be used, such as incremental reduction, binary search, or f-race. The search loop stops when a given stooping criterion is reached such as time, solution quality, number of trials, other criterion, or any combination of stooping criteria. Therefore, the PCI assignment algorithm can be implemented on a closed-loop, zero-touch system.

A penalization function can be applied to regular neighbors that violate one or more constraints. The penalization function can take several forms, depending on the user 214 who can choose different strategies. An example strategy assumes the following: (1) direct collisions and confusions are top priority constraints since they impair communication establishment and handovers; and (2) module collisions do not impair communication but delay the communication establishment. Using this example strategy, two example scenarios will now be described.

Example scenario 1 employs full relaxation wherein relaxations are allowed on direct and module collisions and on confusion constraints. In scenario 1, the MNO guarantees that the penalty applied to the violations of direct collisions and confusion is greater than the total amount of penalization applied to the violations of the module collisions. This can be done using a single penalization function combining such violation penalties after a normalization step. Alternatively, a lexicographical combination of penalization functions can give priority to direct collisions and confusion violations over module collision violations. For example, let D={(a, b): a and b are neighbors} be a set of direct relations between nodes. Let I={(b, c): (a, b) and (a, c) ∈ I, and (b, c) ∉ I} be a set of indirect relations between nodes (used to compute the confusions). Assume xᵣ=1 for r ∈ D ∪ I if neighbor relation r causes a direct collision or a confusion. Assume yᵣ=1 for r ∈ D if neighbor relation r causes a module collision. Assume p¹(x) is the penalization function over x, and p²(y) is the penalization function associated to y. Then, p¹(x)>p²(y) for any xᵢ=1 and all yⱼ=1;

Example scenario 2 employs only one constraint type that can be violated: the module assignment for regular nodes. Therefore, only one penalization function is utilized. Penalization functions can be any type of function such as counting functions (single sum), weighted sums, power functions, and the like. It should be noted that the penalization component can be used within the optimization objective functions. Therefore, a normalization step can be used to combine such values. This is dependent upon the objective function use during the optimization. For example, the MNO may want to minimize the number of module assignment collisions for regular neighbors and the number of changes in the network 202. In this case, the user 214 may choose to use a (linear) combination between such objectives, and therefore, proper normalization and weighting is needed. Using a lexicographical multi-objective strategy, the normalization may not be needed.

The foregoing examples are of the utilization of ranking. Although two example scenarios have been described, the user 214 may build other scenarios with different constraint decompositions and penalization functions. In any case, penalizations should be combined, so that an optimizer can guide the search for better solutions (e.g., less or no constraint violation, and/or better values for the objective functions).

The neighborhood relations ranking can be utilized for RSI assignment. In RSI assignment, the neighborhood relations can be grouped into three categories as described above: top neighbors, regular neighbors, and ignored neighbors. A top neighbor ranking is less than or equal to a ranking threshold “top_rank.” For such RAN nodes 102, all RSI constraints are enforced. That is, the MNO should guarantee that the RSIs for the two nodes in the relationship are apart a given minimum RSI distance. A regular neighbor ranking is greater than the ranking threshold “top_rank,” but less than the ranking threshold “ignored_rank.” The MNO allow RSIs without respect to the minimum RSI distance. However, the MNO may penalize module collisions using a penalization function, which can be any function as described above for PCI assignments. An ignored neighbor ranking allows for one or more constraints (if not all) to be relaxed. That is, the relation will be nonexistent for that set of constraints. In general, ignored neighbors can be removed from the optimization and no constraint takes effect over those pairs of nodes. As with PCI assignments, the user 214 can set up thresholds or the ranking application 206 can dynamically set up thresholds for the search operation during an optimization step.

Turning now to FIG. 3, an example RAN node architecture 300 illustrating aspects of a RAN node 102 introduced above with respect to FIGS. 1 and 2 will be described. The example RAN node architecture illustrated in FIG. 3 includes one or more RAN node processors 302, one or more RAN node memory components 304, one or more baseband units (“BBUs”) 306, one or more remote radio heads (“RRHs”) 308, one or more RAN node operating systems 310, one or more RAN node applications 312, and an antenna system 314, including an antenna array 316 and antenna software 318. Each of these components will now be described in detail.

A RAN node processor 302 can include one or more processing units configured to process data, execute computer-executable instructions of one or more application programs, and communicate with other components of the RAN node architecture 300 in order to perform various functionality described herein. The RAN node processor 302 may be utilized to execute aspects of the RAN node operating system(s) 310 and the RAN node application(s) 312. In some embodiments, the RAN node processor 302 is or includes a central processing unit (“CPU”), a communications processor, or a field-programmable gate array (“FPGA”). In some embodiments, the RAN node processor 302 is or is included in a system-on-a-chip (“SoC”) along with one or more of the other components described herein below. For example, the SoC may include the RAN node processor 302, a graphics processing unit (“GPU”), the BBU(s) 306, the RRH(s) 308, or some combination thereof. In some embodiments, the RAN node processor 302 is fabricated, in part, utilizing a package-on-package (“PoP”) integrated circuit packaging technique. Moreover, the RAN node processor 302 may be a single core or multi-core processor. The RAN node processor 302 may be created in accordance with an ARM architecture, available for license from ARM HOLDINGS of Cambridge, United Kingdom. Alternatively, the RAN node processor 302 may be created in accordance with an x86 architecture, such as is available from INTEL CORPORATION of Mountain View, California and others. In some embodiments, the RAN node processor 302 is a SNAPDRAGON SoC, available from QUALCOMM of San Diego, California, a TEGRA SoC, available from NVIDIA of Santa Clara, California, a HUMMINGBIRD SoC, available from SAMSUNG of Seoul, South Korea, an OMAP SoC, available from TEXAS INSTRUMENTS of Dallas, Texas, a customized version of any of the above SoCs, or a proprietary SoC.

The RAN node memory components 304 can include a random-access memory (“RAM”), a read-only memory (“ROM”), an integrated storage memory, and a removable storage memory, or some combination thereof. In some embodiments, the RAN node memory components 304 store the RAN node operating system(s) 310 or a portion thereof (e.g., operating system kernel or bootloader), and/or the RAN node application(s) 312.

The BBU 306 is the baseband processing unit of the RAN node architecture 300. The BBU 306 can include other components shown, including, for example, the RAN node processor(s) 302, the RAN node memory component(s) 304, the RAN node operating system(s) 310, the RAN node application(s) 312, or some combination thereof. The BBU 306 can receive IP packets from a core network and can modulate the IP packets into digital baseband signals. The BBU 306 can send the digital baseband signals to the RRH(s) 308. The digital baseband signals received by the RRH(s) 308 can be demodulated and IP packets can be transmitted to the core network. The RRH(s) 308 can transmit and receive wireless signals to/from devices such as the UEs 104. The RRH(s) 308 also convert the digital baseband signals from the BBU 306 that have been subjected to protocol-specific processing into RF signals and power amplifies the signals for transmission to the devices such as the UEs 104. The RF signals received from the devices are amplified and converted to digital baseband signals for transmission to the BBU 306.

The RAN node operating system 310 is a program for controlling the operation of the RAN node architecture 300. The RAN node operating system 310 can include a proprietary operating system, an embedded operating system, and/or other operating systems. These operating systems are merely illustrative of some contemplated operating systems that may be used in accordance with various embodiments of the concepts and technologies described herein and therefore should not be construed as being limiting in any way.

A RAN node application 312 can be any application that performs operations for the RAN node architecture 300. For example, the RAN node application(s) 312 can be or can include software compliant with 3GPP technical specifications for call control processing, performance management, self-organizing network functions, and the like.

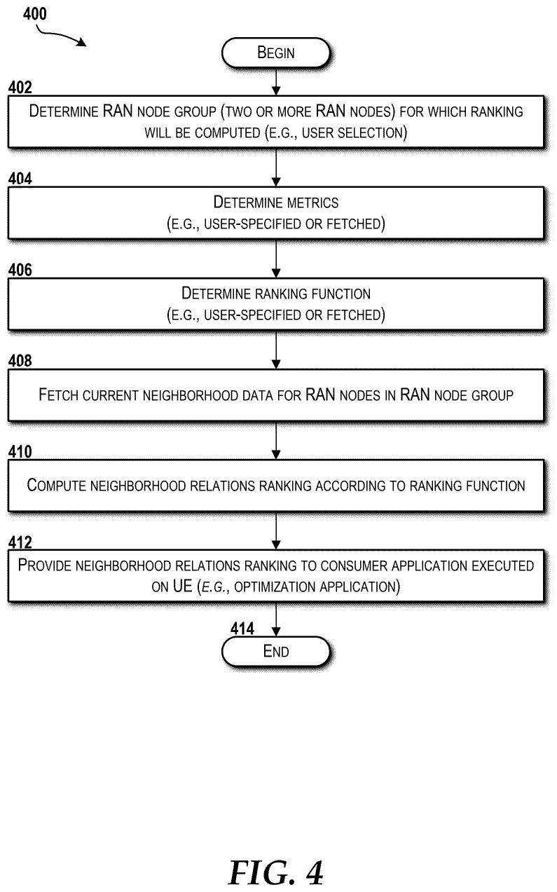

Turning now to FIG. 4, a method 400 for building a neighborhood relations ranking will be described, according to an illustrative embodiment of the concepts and technologies disclosed herein. It should be understood that the operations of the method disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 400 begins and proceeds to operation 402. At operation 402, the SDN controller 204, via execution of the ranking application 206, determines a RAN node group 208 for which a ranking will be computed. For example, the user 214, such as a network engineer, can select the RAN node group 208 for which a ranking will be computed. Alternatively, the ranking application 206 can select RAN node groups 208 systematically or based upon data such as the current neighborhood data 228.

From operation 402, the method 400 proceeds to operation 404. At operation 404, the SDN controller 204 determines one or more metrics to be used for computing the ranking. The metrics can include one or more user-specified metrics 216. The user 214 can explicitly define the metric(s) to be used. For example, the user-specified metrics 216 can be the number of handovers for all neighborhood relations. Alternatively, the ranking application 206 can fetch one or more metrics 220 from a metrics library 222, which can be provided, at least in part, by the MNO and/or a third party. The ranking application 206 can fetch the metric(s) 220 used recently (e.g., within the last day, week, month, or year depending upon the needs of a given implementation) or the metric(s) 220 used most frequently for a given neighborhood relation. For instance, the ranking application 206 may select a coverage area for the neighborhood relation between the RAN node₁ 102A and the RAN node₂ 102B, since this may be the metric 220 most frequently used between this RAN node 102 pair.

From operation 404, the method proceeds to operation 406. At operation 406, the SDN controller 204 determines a ranking function to be used for computing the ranking. The ranking function can be specified by the user (i.e., user-specified ranking function) or fetched from the ranking function library (i.e., ranking function). Likewise, the ranking application 206 can fetch a ranking function 224 from the ranking functions library 226. Similar to the metrics 220, the ranking function 224 may be attached to historical usage according to the given RAN nodes 102. For example, a given market may use “the non-decreasing order of the average of the number of handovers within a week” for its neighborhood relations ranking.

From operation 406, the method 400 proceeds to operation 408. At operation 408, the SDN controller 204 fetches current neighborhood relations and any associated metrics 220 for the given node group 208 (shown generally as current neighborhood data 228 in FIG. 2). For time series, aggregation of this data can be done at the database level or at the application level.

From operation 408, the method 400 can proceed to operation 410. At operation 410, using the metric(s) 216/220 (user-specified and/or fetched), the ranking function 218/224 (user-specified or fetched), and the current neighborhood data 228, the ranking application 206 can compute the ranks according to the ranking function 218/224. In some implementations, due to the potentially time-consuming, resource-intensive, and expensive nature of this computation, this computation can be handled in a distributed fashion, such as among multiple ranking applications 206 executed by multiple SDN controllers 204 or at least partially offsite, such as in a cloud computing network. It is possible that the incoming data is not completely clear or ready to use. For instance, a given neighborhood relation may have several rankings. In such situations, the ranking function 218/224 can handle the incoming data directly or via one or more cleaning and normalization policies prior to handling.

From operation 410, the method 400 proceeds to operation 412. At operation 412, the SDN controller 204 forwards the neighborhood relations ranking to the optimization application 212 executed on the UE 104, such as a PCI or RSI optimizer that includes the ranking API 210.

From operation 412, the method 400 proceeds to operation 414. The method 400 can end at operation 414.

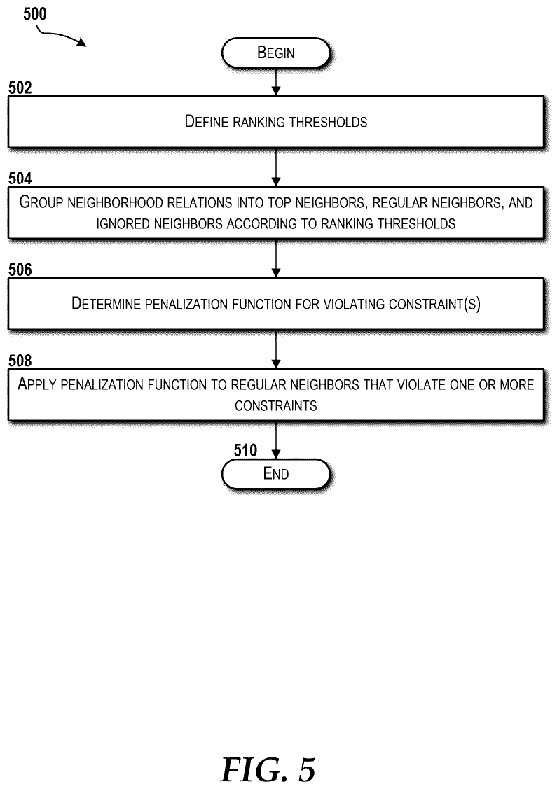

Turning now to FIG. 5, a method 500 for utilizing the neighborhood relations ranking for PCI or RSI assignments will be described, according to an illustrative embodiment. The method 500 begins and proceeds to operation 502. At operation 502, the SDN controller 204 defines the thresholds “top_rank” and “ignored_rank” based upon input provided by the user 214 or that can be extracted from historical usage for a specific node group 208. For example, the user 214 (on behalf of the MNO) may provide input that defines “top_rank=10” and “ignored_rank=30” for market “A”, and “top_rank=25” and “ignored_rank=50” for market “B”. These thresholds also can be defined dynamically by the PCI assignment algorithm. The PCI assignment algorithm may start with large “top_rank” and “ignored_rank,” which probably will result in an infeasible use case (i.e., no feasible solution or assignment can be found using such values). Then, the optimization application 212 may reduce its values iteratively until a feasible solution is found or a solution within the limits expected by the user 214 is found. Any reducing strategy can be used, such as incremental reduction, binary search, or f-race. The search loop stops a given stooping criterion is reached such as time, solution quality, number of trials, other criterion, or any combination of stooping criteria.

From operation 502, the method 500 proceeds to operation 504. At operation 504, the SDN controller 204 can group neighborhood relations according to the ranking thresholds. In the example described above, the neighborhood relations can be grouped into three categories: top neighbors, regular neighbors, and ignored neighbors. A top neighbor ranking is less than or equal to the ranking threshold “top_rank.” For such RAN nodes 102, all PCI constraints are enforced, especially the module-assignment constraints. A regular neighbor ranking is greater than the ranking threshold “top_rank,” but less than the ranking threshold “ignored_rank.” For these neighbors, module-assignment collision may be allowed, but no direct collisions or confusion are allowed. Alternatively, direct collisions or confusions may be allowed but module collusions may be penalized using a penalization function. An ignored neighbor ranking allows for one or more constraints (if not all) to be relaxed. That is, the relation will be nonexistent for that set of constraints. In general, ignored neighbors can be removed from the optimization and no constraint takes effect over those pairs of nodes. An ignored neighbor has a rank greater than or equal to the ranking threshold “ignored_rank.”

From operation 504, the method 500 proceeds to operation 506. At operation 506, the SDN controller 204 can determine a penalization function to be used when regular neighbors violate one or more constraints. From operation 506, the method 500 proceeds to operation 508. At operation 508, the SDN controller 204 can apply the penalization function to regular neighbors that violated one or more constraints. The penalization function can take several forms, depending on the user 214 who can choose different strategies. An example strategy assumes the following: (1) direct collisions and confusions are top priority constraints since they impair communication establishment and handovers; and (2) module collisions do not impair communication but delay the communication establishment. Two example scenarios are described above.

From operation 508, the method 500 proceeds to operation 510. The method 500 can end at operation 510.

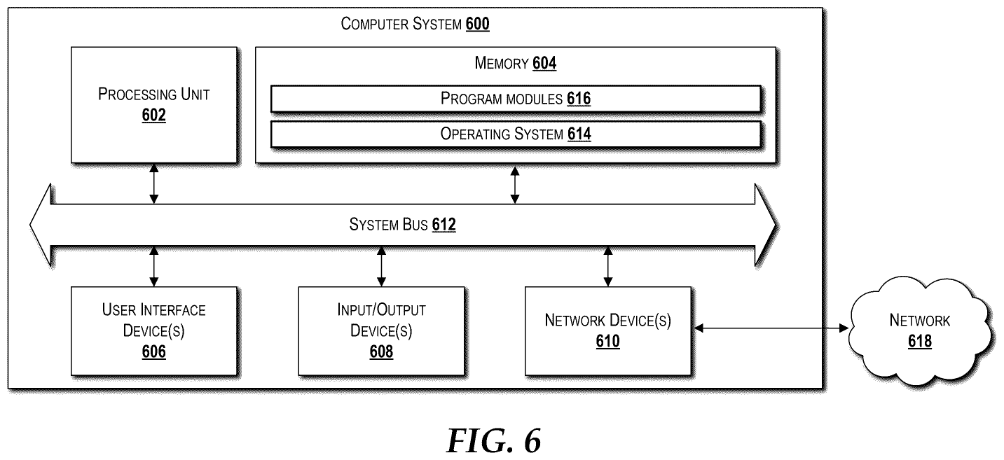

Turning now to FIG. 6, a block diagram illustrating a computer system 600 configured to provide the functionality described herein in accordance with various embodiments. In some embodiments, one or more of the UEs 104, the SDN controller(s) 204, and/or other systems/devices described herein can be configured the same as or similar to the computer system 600.

The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 602 can be a single processing unit or a multiple processing unit that includes more than one processing component. Processing units are generally known, and therefore are not described in further detail herein.

The memory 604 communicates with the processing unit 602 via the system bus 612. The memory 604 can include a single memory component or multiple memory components. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS family of operating systems from MICROSOFT CORPORATION, the LINUX family of operating systems, families of operating systems from APPLE CORPORATION, other operating systems, and/or the like.

The program modules 616 may include various software and/or program modules described herein. In some embodiments, multiple implementations of the computer system 600 can be used, wherein each implementation is configured to execute one or more of the program modules 616. The program modules 616 and/or other programs can be embodied in computer-readable media containing instructions that, when executed by the processing unit 602, perform the methods 400/500 described herein. According to embodiments, the program modules 616 may be embodied in hardware, software, firmware, or any combination thereof.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium,” “computer-readable storage medium,” and variations thereof does not include waves or signals per se and/or communication media, and therefore should be construed as being directed to “non-transitory” media only.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display or printer.

The network devices 610 enable the computer system 600 to communicate with other networks or remote systems via the network(s) 618, such as the network 202. Examples of the network devices 610 include, but are not limited to, a modem, a radio frequency (“RF”) or infrared (“IR”) transceiver, a telephonic interface, a bridge, a router, or a network card. The network 618 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Additionally, the network 618 can be or can include a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 7, an illustrative mobile device 700 and components thereof will be described. In some embodiments, the UEs 104 can be configured the same as or similar to the mobile device 700. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 700 can also include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in the memory 706, or the like. The application(s) 710 can include the optimization application 212 configured to call the ranking API 210.

The UI application can interface with the operating system 708 to facilitate user interaction with functionality and/or data stored at the mobile device 700 and/or stored elsewhere. In some embodiments, the operating system 708 can include a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering/deleting data, entering and setting user IDs and passwords for device access, configuring settings, manipulating content and/or settings, multimode interaction, interacting with other applications 710, and otherwise facilitating user interaction with the operating system 708, the applications 710, and/or other types or instances of data 712 that can be stored at the mobile device 700.

The applications 710, the data 712, and/or portions thereof can be stored in the memory 706 and/or in a firmware 714, and can be executed by the processor 704. The firmware 714 can also store code for execution during device power up and power down operations. It can be appreciated that the firmware 714 can be stored in a volatile or non-volatile data storage device including, but not limited to, the memory 706 and/or a portion thereof.

The mobile device 700 can also include an input/output (“I/O”) interface 716. The I/O interface 716 can be configured to support the input/output of data such as location information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 can also include a communications component 718. The communications component 718 can be configured to interface with the processor 704 to facilitate wired and/or wireless communications with one or more networks, such as the network 202, the Internet, or some combination thereof. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments, one or more of the transceivers of the communications component 718 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 718 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 718 can include a first transceiver (“TxRx”) 720A that can operate in a first communications mode (e.g., GSM). The communications component 718 can also include an N^{th} transceiver (“TxRx”) 720N that can operate in a second communications mode relative to the first transceiver 720A (e.g., UMTS). While two transceivers 720A-720N (hereinafter collectively and/or generically referred to as “transceivers 720”) are shown in FIG. 7, it should be appreciated that less than two, two, and/or more than two transceivers 720 can be included in the communications component 718.

The communications component 718 can also include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 can also facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 can also include one or more sensors 724. The sensors 724 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 can also include a subscriber identity module (“SIM”) system 728. The SIM system 728 can include a universal SIM (“USIM”), a universal integrated circuit card (“UICC”), eSIM, and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 can also include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another device. The video and/or photo content can also be shared with other devices via various types of data transfers via wired and/or wireless communication devices as described herein.

The mobile device 700 can also include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 can also be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 can also include a power source 738. The power source 738 can include one or more batteries, power supplies, power cells, and/or other power subsystems including alternating current (“AC”) and/or direct current (“DC”) power devices. The power source 738 can also interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 700 or other devices or computers described herein, such as the computer system 600 described above with reference to FIG. 6. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 700 in order to store and execute the software components presented herein. It is also contemplated that the mobile device 700 may not include all of the components shown in FIG. 7, may include other components that are not explicitly shown in FIG. 7, or may utilize an architecture completely different than that shown in FIG. 7.

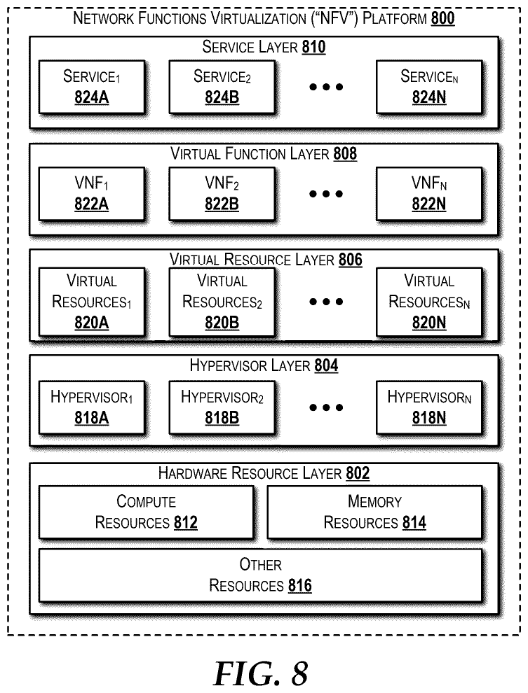

Turning now to FIG. 8, an illustrative network functions virtualization (“NFV”) platform 800 will be described, according to an illustrative embodiment. In some embodiments, the network 202 is built, at least in part, upon the NFV platform 800. The NFV platform 800 includes a hardware resource layer 802, a hypervisor layer 804, a virtual resource layer 806, a virtual function layer 808, and a service layer 810. While no connections are shown between the layers illustrated in FIG. 8, it should be understood that some, none, or all of the components illustrated in FIG. 8 can be configured to interact with one other to carry out various functions described herein. In some embodiments, the components are arranged so as to communicate via one or more networks. Thus, it should be understood that FIG. 8 and the remaining description are intended to provide a general understanding of a suitable environment in which various aspects of the embodiments described herein can be implemented and should not be construed as being limiting in any way.

The hardware resource layer 802 includes one or more compute resources 812, one or more memory resources 814, and one or more other resources 816. The compute resource(s) 812 can include one or more hardware components that perform computations to process data and/or to execute computer-executable instructions of one or more application programs, one or more operating systems, and/or other software. In particular, the compute resources 812 can include one or more CPUs configured with one or more processing cores. The compute resources 812 can include one or more GPUs configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 812 can include one or more discrete GPUs. In some other embodiments, the compute resources 812 can include CPU and GPU components that are configured in accordance with a co-processing CPU/GPU computing model, wherein the sequential part of an application executes on the CPU and the computationally-intensive part is accelerated by the GPU processing capabilities. The compute resources 812 can include one or more SoC components along with one or more other components, including, for example, one or more of the memory resources 814, and/or one or more of the other resources 816. In some embodiments, the compute resources 812 can be or can include one or more SNAPDRAGON SoCs, available from QUALCOMM of San Diego, California; one or more TEGRA SoCs, available from NVIDIA of Santa Clara, California; one or more HUMMINGBIRD SoCs, available from SAMSUNG of Seoul, South Korea; one or more OMAP SoCs, available from TEXAS INSTRUMENTS of Dallas, Texas; one or more customized versions of any of the above SoCs; and/or one or more proprietary SoCs. The compute resources 812 can be or can include one or more hardware components architected in accordance with an ARM architecture, available for license from ARM HOLDINGS of Cambridge, United Kingdom. Alternatively, the compute resources 812 can be or can include one or more hardware components architected in accordance with an x86 architecture, such an architecture available from INTEL CORPORATION of Mountain View, California, and others. Those skilled in the art will appreciate the implementation of the compute resources 812 can utilize various computation architectures, and as such, the compute resources 812 should not be construed as being limited to any particular computation architecture or combination of computation architectures, including those explicitly disclosed herein.

The memory resource(s) 814 can include one or more hardware components that perform storage/memory operations, including temporary or permanent storage operations. In some embodiments, the memory resource(s) 814 include volatile and/or non-volatile memory implemented in any method or technology for storage of information such as computer-readable instructions, data structures, program modules, or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the compute resources 812.

The other resource(s) 816 can include any other hardware resources that can be utilized by the compute resources(s) 812 and/or the memory resource(s) 814 to perform operations described herein. The other resource(s) 816 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more hypervisors 818A-818N (also known as “virtual machine monitors”) operating within the hypervisor layer 804 to create virtual resources that reside in the virtual resource layer 806. The hypervisors 816A-816N can be or can include software, firmware, and/or hardware that alone or in combination with other software, firmware, and/or hardware, creates and manages virtual resources 820A-820N operating within the virtual resource layer 806.

The virtual resources 820A-820N operating within the virtual resource layer 806 can include abstractions of at least a portion of the compute resources 812, the memory resources 814, and/or the other resources 816, or any combination thereof. In some embodiments, the abstractions can include one or more virtual machines, virtual volumes, virtual networks, and/or other virtualizes resources upon which one or more virtual network functions (“VNFs”) 822A-822N can be executed. The VNFs 822A-822N in the virtual function layer 808 are constructed out of the virtual resources 820A-820N in the virtual function layer 808. In the illustrated example, the VNFs 822A-822N can provide, at least in part, one or more services 824A-824N in the service layer 810.

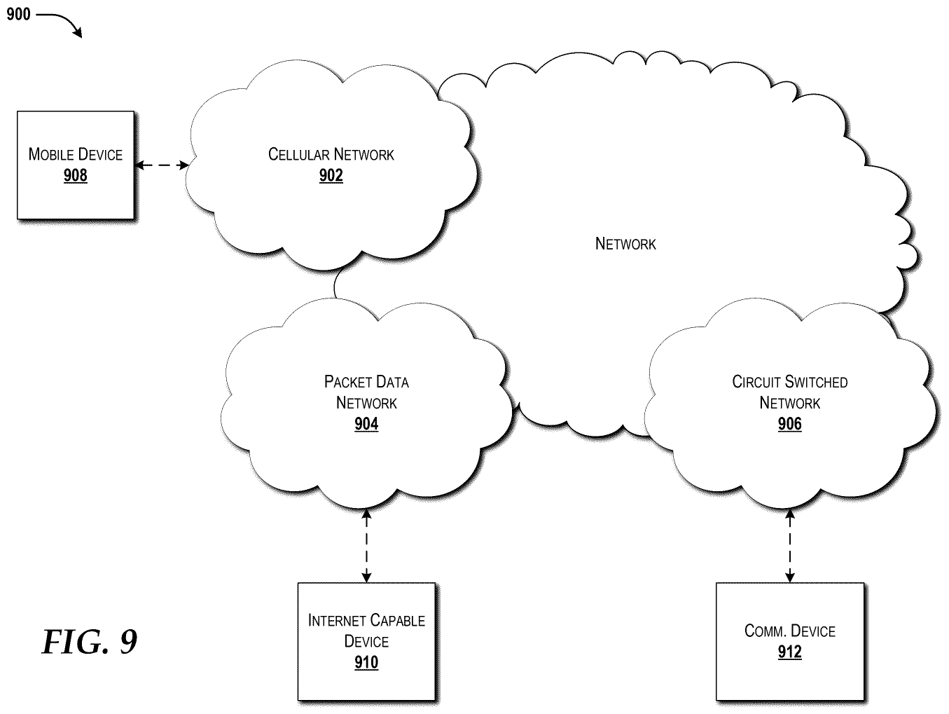

Turning now to FIG. 9, details of a network 900 are illustrated, according to an illustrative embodiment. In some embodiments, the network 202 shown in FIG. 2 can be configured the same as or similar to the network 900. The network 900 includes a cellular network 902, a packet data network 904, and a circuit switched network 906 (e.g., a public switched telephone network). The cellular network 902 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 902 also includes radios and nodes for receiving and transmitting voice, data, and combinations thereof to and from radio transceivers, networks, the packet data network 904, and the circuit switched network 906.

A mobile communications device 908, such as, for example, the UEs 104, a cellular telephone, a user equipment, a mobile terminal, a PDA, a laptop computer, a handheld computer, and combinations thereof, can be operatively connected to the cellular network 902. The mobile communications device 908 can be configured similar to or the same as the mobile device 700 described above with reference to FIG. 7.

The cellular network 902 can be configured as a GSM network and can provide data communications via GPRS and/or EDGE. Additionally, or alternatively, the cellular network 902 can be configured as a 3G Universal Mobile Telecommunications System (“UMTS”) network and can provide data communications via the HSPA protocol family, for example, HSDPA, EUL, and HSPA+. The cellular network 902 also is compatible with mobile communications standards such as LTE, or the like, as well as evolved and future mobile standards.

The packet data network 904 includes various systems, devices, servers, computers, databases, and other devices in communication with one another, as is generally known. In some embodiments, the packet data network 904 is or includes one or more WI-FI networks, each of which can include one or more WI-FI access points, routers, switches, and other WI-FI network components. The packet data network 904 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 904 includes or is in communication with the Internet. The circuit switched network 906 includes various hardware and software for providing circuit switched communications. The circuit switched network 906 may include, or may be, what is often referred to as a plain old telephone system (“POTS”). The functionality of a circuit switched network 906 or other circuit-switched network are generally known and will not be described herein in detail.

The illustrated cellular network 902 is shown in communication with the packet data network 904 and a circuit switched network 906, though it should be appreciated that this is not necessarily the case. One or more Internet-capable systems/devices 910 such as a laptop, a portable device, or another suitable device, can communicate with one or more cellular networks 902, and devices connected thereto, through the packet data network 904. It also should be appreciated that the Internet-capable device 910 can communicate with the packet data network 904 through the circuit switched network 906, the cellular network 902, and/or via other networks (not illustrated).

As illustrated, a communications device 912, for example, a telephone, facsimile machine, modem, computer, or the like, can be in communication with the circuit switched network 906, and therethrough to the packet data network 904 and/or the cellular network 902. It should be appreciated that the communications device 912 can be an Internet-capable device, and can be substantially similar to the Internet-capable device 910.

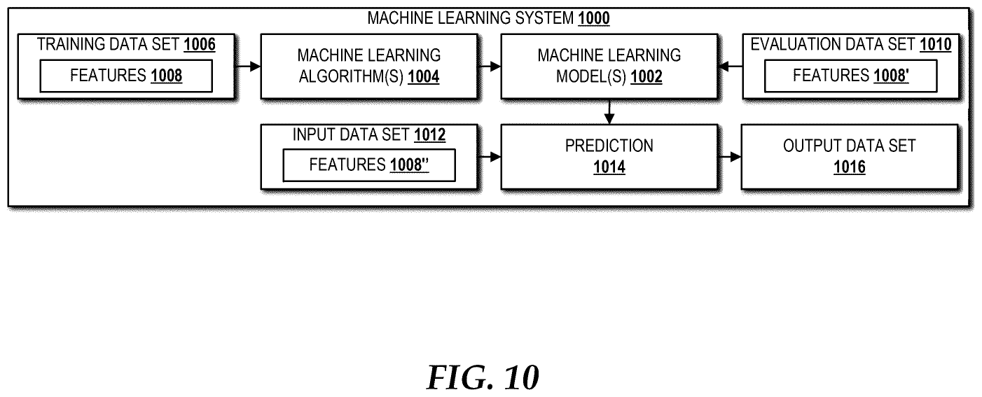

Turning now to FIG. 10, a machine learning system 1000 capable of implementing aspects of the embodiments disclosed herein will be described. In some embodiments, aspects of the ranking application 206 and/or the optimization application 212 can be improved via machine learning. Accordingly, or a combination thereof can include or can be in communication with a machine learning system 1000 or multiple machine learning systems 1000.

The illustrated machine learning system 1000 includes one or more machine learning models 1002. The machine learning models 1002 can include, unsupervised, supervised, and/or semi-supervised learning models. The machine learning model(s) 1002 can be created by the machine learning system 1000 based upon one or more machine learning algorithms 1004. The machine learning algorithm(s) 1004 can be any existing, well-known algorithm, any proprietary algorithms, or any future machine learning algorithm. Some example machine learning algorithms 1004 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 1004 based upon the problem(s) to be solved by machine learning via the machine learning system 1000.

The machine learning system 1000 can control the creation of the machine learning models 1002 via one or more training parameters. In some embodiments, the training parameters are selected modelers at the direction of an enterprise, for example. Alternatively, in some embodiments, the training parameters are automatically selected based upon data provided in one or more training data sets 1006. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 1004 converges to the optimal weights. The machine learning algorithm 1004 can update the weights for every data example included in the training data set 1006. The size of an update is controlled by the learning rate. A learning rate that is too high might prevent the machine learning algorithm 1004 from converging to the optimal weights. A learning rate that is too low might result in the machine learning algorithm 1004 requiring multiple training passes to converge to the optimal weights.

The model size is regulated by the number of input features (“features”) 1008 in the training data set 1006. A greater the number of features 1008 yields a greater number of possible patterns that can be determined from the training data set 1006. The model size should be selected to balance the resources (e.g., compute, memory, storage, etc.) needed for training and the predictive power of the resultant machine learning model 1002.

The number of training passes indicates the number of training passes that the machine learning algorithm 1004 makes over the training data set 1006 during the training process. The number of training passes can be adjusted based, for example, on the size of the training data set 1006, with larger training data sets being exposed to fewer training passes in consideration of time and/or resource utilization. The effectiveness of the resultant machine learning model 1002 can be increased by multiple training passes.

Data shuffling is a training parameter designed to prevent the machine learning algorithm 1004 from reaching false optimal weights due to the order in which data contained in the training data set 1006 is processed. For example, data provided in rows and columns might be analyzed first row, second row, third row, etc., and thus an optimal weight might be obtained well before a full range of data has been considered. By data shuffling, the data contained in the training data set 1006 can be analyzed more thoroughly and mitigate bias in the resultant machine learning model 1002.

Regularization is a training parameter that helps to prevent the machine learning model 1002 from memorizing training data from the training data set 1006. In other words, the machine learning model 1002 fits the training data set 1006, but the predictive performance of the machine learning model 1002 is not acceptable. Regularization helps the machine learning system 1000 avoid this overfitting/memorization problem by adjusting extreme weight values of the features 1008. For example, a feature that has a small weight value relative to the weight values of the other features in the training data set 1006 can be adjusted to zero.

The machine learning system 1000 can determine model accuracy after training by using one or more evaluation data sets 1010 containing the same features 1008′ as the features 1008 in the training data set 1006. This also prevents the machine learning model 1002 from simply memorizing the data contained in the training data set 1006. The number of evaluation passes made by the machine learning system 1000 can be regulated by a target model accuracy that, when reached, ends the evaluation process and the machine learning model 1002 is considered ready for deployment.

After deployment, the machine learning model 1002 can perform a prediction operation (“prediction”) 1014 with an input data set 1012 having the same features 1008″ as the features 1008 in the training data set 1006 and the features 1008′ of the evaluation data set 1010. The results of the prediction 1014 are included in an output data set 1016 consisting of predicted data. The machine learning model 1002 can perform other operations, such as regression, classification, and others. As such, the example illustrated in FIG. 10 should not be construed as being limiting in any way.

Based on the foregoing, it should be appreciated that aspects of neighborhood relaxation for PCI and RSI assignment optimization have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
determining, by a software-defined network (“SDN”) controller executing a ranking application, a radio access network (“RAN”) node group comprising at least two RAN nodes for which a neighborhood relations ranking is to be computed;
determining, by the SDN controller, at least one metric;
determining, by the SDN controller, a ranking function;
fetching, by the SDN controller, current neighborhood data for the at least two RAN nodes in the RAN node group;
computing, by the SDN controller, the neighborhood relations ranking according to the ranking function and based upon the at least one metric and the current neighborhood data; and
providing, by the SDN controller, the neighborhood relations ranking to a user equipment.

2. The method of claim 1, wherein determining the RAN node group comprises receiving a user selection of the at least two RAN nodes in the RAN node group.

3. The method of claim 1, wherein determining the at least one metric comprises receiving at least one user-specified metric.

4. The method of claim 1, wherein determining the at least one metric comprises fetching the at least one metric from a metric library.

5. The method of claim 4, wherein the metric library comprises a plurality of key performance indicators and the at least one metric comprises at least one key performance indicator of the plurality of key performance indicators.

6. The method of claim 1, wherein providing the neighborhood relations ranking to the user equipment comprises providing the neighborhood relations ranking to the user equipment via an application programming interface called by an optimization application executing on the user equipment.

7. The method of claim 1, further comprising:
defining, by the SDN controller, a plurality of ranking thresholds;
grouping, by the SDN controller, neighborhood relations into top neighbors, regular neighbors, and ignored neighbors according to the plurality of ranking thresholds;
determining, by the SDN controller, a penalization function for violating at least one constraint; and
applying, by the SDN controller, the penalization function to the regular neighbors that violate the at least one constraint.

8. A software-defined network (“SDN”) controller comprising:
a processor; and
a memory comprising instructions that, when executed by the processor, cause the processor to perform operations comprising
determining a radio access network (“RAN”) node group comprising at least two RAN nodes for which a neighborhood relations ranking is to be computed,
determining at least one metric,
determining, a ranking function,
fetching current neighborhood data for the at least two RAN nodes in the RAN node group,
computing the neighborhood relations ranking according to the ranking function and based upon the at least one metric and the current neighborhood data, and
providing the neighborhood relations ranking to a user equipment.

9. The SDN controller of claim 8, wherein determining the RAN node group comprises receiving a user selection of the at least two RAN nodes in the RAN node group.

10. The SDN controller of claim 8, wherein determining the at least one metric comprises receiving at least one user-specified metric.

11. The SDN controller of claim 8, wherein determining the at least one metric comprises fetching the at least one metric from a metric library.

12. The SDN controller of claim 11, wherein the metric library comprises a plurality of key performance indicators and the at least one metric comprises at least one key performance indicator of the plurality of key performance indicators.

13. The SDN controller of claim 8, wherein providing the neighborhood relations ranking to the user equipment comprises providing the neighborhood relations ranking to the user equipment via an application programming interface called by an optimization application executing on the user equipment.

14. The SDN controller of claim 8, wherein the operations further comprise:
defining a plurality of ranking thresholds;
grouping neighborhood relations into top neighbors, regular neighbors, and ignored neighbors according to the plurality of ranking thresholds;
determining a penalization function for violating at least one constraint; and
applying the penalization function to the regular neighbors that violate the at least one constraint.

15. A computer-readable storage medium comprising computer-executable instructions that, when executed by a processor of a software-defined network (“SDN”) controller, cause the processor to perform operations comprising:
determining a radio access network (“RAN”) node group comprising at least two RAN nodes for which a neighborhood relations ranking is to be computed;
determining at least one metric;
determining, a ranking function;
fetching current neighborhood data for the at least two RAN nodes in the RAN node group;
computing the neighborhood relations ranking according to the ranking function and based upon the at least one metric and the current neighborhood data; and
providing the neighborhood relations ranking to a user equipment.

16. The computer-readable storage medium of claim 15, wherein determining the RAN node group comprises receiving a user selection of the at least two RAN nodes in the RAN node group.

17. The computer-readable storage medium of claim 15, wherein determining the at least one metric comprises receiving at least one user-specified metric.

18. The computer-readable storage medium of claim 15, wherein determining the at least one metric comprises fetching the at least one metric from a metric library, and wherein the metric library comprises a plurality of key performance indicators and the at least one metric comprises at least one key performance indicator of the plurality of key performance indicators.

19. The computer-readable storage medium of claim 15, wherein providing the neighborhood relations ranking to the user equipment comprises providing the neighborhood relations ranking to the user equipment via an application programming interface called by an optimization application executing on the user equipment.

20. The computer-readable storage medium of claim 15, wherein the operations further comprise:
defining a plurality of ranking thresholds;
grouping neighborhood relations into top neighbors, regular neighbors, and ignored neighbors according to the plurality of ranking thresholds;
determining a penalization function for violating at least one constraint; and
applying the penalization function to the regular neighbors that violate the at least one constraint.
